(19) United States
(12) Patent Application Publication
(10) Pub. No.: US 2001/0039610 A1
(43) Pub. Date: Nov. 8, 2001

(54) Data processing device, method of operating a data processing device and method for compiling a program

(76) Inventors: Natalino Giorgio Busa, Eindhoven (NL); Albert Van Der Werf, Eindhoven (NL); Paul Eugene Richard Lippens, Eindhoven (NL)

Correspondence Address: Corporate Patent Counsel, U.S. Philips Corporation, 580 White Plains Road, Tarrytown, NY, 10591, US

(21) Appl. No.: 09/801,080

(22) Filed: Mar. 7, 2001

(30) Foreign Application Priority Data
Mar. 10, 2000 (EP) 00200870.4

(51) Int. Cl. G06F 7/38; G06F 9/00

(52) U.S. Cl. 712/225; 717/5

(57) ABSTRACT

A data processing device is described which at least comprises a master controller (1), a first functional unit (2) which includes a slave controller (20), a second functional unit (3). The functional units (2,3) share common memory means (11). The device is programmed for executing an instruction by the first functional unit (2), the execution of said instruction involving input/output operations by the first functional unit (3), wherein output data of the first functional unit (2) is processed by the second functional unit (3) during said execution and/or the input data is generated by the second functional (3) unit during said execution.

The present invention relates to a data processing device.

The invention further relates to a method of operating a data processing device.

The invention further relates to a method for compiling a program.

Modern signal processing systems are designed to support multiple standards and to provide high performance. Multimedia and telecom are typical areas where such combined requirements can be found. The need for high performance leads to architectures that may include application specific hardware accelerators. In the HW/SW co-design community, “mapping” refers to the problem of assigning the functions of the application program to a set of operations that can be executed by the available hardware components [1][2]. Operations may be arranged in two groups according to their complexity: fine-grain and coarse-grain operations.

Examples of fine-grain operations are addition, multiplication, and conditional jump. They are performed in a few clock cycles and only a few input values are processed at a time. Coarse-grain operations process a bigger amount of data and implement a more complex functionality such as FFT-butterfly, DCT, or complex multiplication.

A hardware component implementing a coarse-grain operation is characterized by a latency that ranges from few cycles to several hundreds of cycles. Moreover, data consumed and produced by the unit is not concentrated at the end and at the beginning of the course grain operation. On the contrary, data communications to and from the unit are distributed during the execution of the whole course grain operation. Consequently, the functional unit exhibits a (complex) timeshape in terms of Input-Output behavior [9]. According to the granularity (coarseness) of the operations, architectures may be grouped in two different categories, namely processor architectures and heterogeneous multi-processor architectures, defined as follows:

Processor architectures: The architecture consists of a heterogeneous collection of Functional Units (FUs) such as ALUs and multipliers. Typical architectures in this context are general-purpose CPU and DSP architectures. Some of these, such as VLIW and superscalar architectures can have multiple operations executed in parallel. The FUs execute fine-grain operations and the data has typically a “word” grain size.

Heterogeneous multi-processor architectures: The architecture is made of dedicated Application Specific Instruction set Processors (ASIPs), ASICs and standard DSPs and CPUs, connected via busses. The hardware executes coarse-grain operations such as a 256 input FFT, hence data has a “block of words” grain size. In this context, operations are often regarded as tasks or processes.

The two architectural approaches above described are always been kept separated.

It is a purpose of the invention to provide a data processing device wherein a (co)-processors are embedded as FUs in a VLIW processor datapath, wherein the VLIW processor can have FUs executing operations having different latencies and working on a variety of data granularities at the same time.

It is a further purpose of the invention to provide a method for operating such a data processing device.

It is a further purpose of the invention to provide a method for compiling a program which efficiently schedules a mixture of fine-grain and coarse-grain operations, minimizing schedule's length and VLIW instruction width.

A data processing device according to the invention at least comprises a master controller, a first functional unit which includes a slave controller, a second functional unit, which functional units share common memory means, the device being programmed for executing an instruction by the first functional unit, the execution of said instruction involving input/output operations by the first functional unit, wherein output data of the first functional unit is processed by the second functional unit during said execution and/or the input data is generated by the second functional unit during said execution.

The first functional unit is for example Application Specific Instruction set Processor (ASIP), an ASIC, a standard DSP or a CPU. The second functional unit typically executes fine-grain operations such as an ALU or a multiplier. The common memory means shared by the first and the second unit may be a program memory which comprises the instructions to be carried out by these units. Otherwise the common memory means may be used for data storage.

Introducing coarse-grain operations has a beneficial influence on the microcode width. Firstly, because FUs executing coarse-grain operations have internally their own controller. Therefore, the VLIW controller needs less instruction bits to steer the entire datapath. Secondly, exploiting the I/O timeshape makes it possible to deliver and consume data even if the operation itself is not completed, hence shortening signals' lifetime and, therefore, the number of datapath registers. The instruction bits needed to address datapath registers and steering in parallel a large number of datapath resources are two important factors contributing to the large width of the VLIW microcode. Ultimately, enhancing the instruction level parallellism (ILP) has a positive influence on the schedule length, and hence, on microcode length. Keeping microcode area small is an essential requisite for embedded applications aiming at high performances and coping with long and complex program codes. The internal schedule of the FUs will be partially taken into account while scheduling the application. In this way, a FU's internal schedule could be considered as embedded in the application's VLIW schedule. Doing so, the knowledge on the I/O timeshape might be exploited to provide or withdraw data from the FU in a “just in time” fashion. The operation can start even if not all data consumed by the unit is available. A FU performing coarse-grain operations can be re-used as well. This means that it can be maintained in the VLIW datapath, while the actual use of its output data will be different.

It is remarked that commercially available DSPs, based on the VLIW architecture are known which limit the complexity of custom operations executed by the datapath's FUs. The R. E. A. L. DSP [3], for instance, allows the introduction of custom units, called Application-specific execution Units (AXU). However, the latency of these functional units is limited to one clock cycle. Other DSPs like the TI ‘C6000[4] may contain FUs with latency ranging from one to four cycles. The Philips Trimedia VLIW architecture [5] allows multi-cycle and pipelined operation ranging from one to three cycles. The architectural level synthesis tool Phideo [10] can handle operations with timeshapes, but is not suited for control-dominated applications. Mistral2 [11] allows the definition of timeshape under the restriction that signals are passed to separate I/O ports of the FU. Currently, no scheduler can cope well with FUs with complex timeshapes. To simplify the scheduler's job, the unit performing a coarse-grain operation is traditionally characterized only by its latency and the operation is regarded as atomic. Consequently, this approach lengthens the schedule because all data must be available before starting the operation, regardless the fact that the unit could already perform some of its computations without having the total amount of input data. This approach lengthens the signals' lifetime as well, increasing the number of needed registers.

A method of operating a dataprocessor device according to the invention is provided. The device comprises at least

a master controller for controlling operation of the device

a first functional unit, which includes a slave controller, the first functional unit being arranged for executing instructions of a first type corresponding to operations having a relatively long latency,

a second functional unit capable of executing instructions of a second type corresponding to operations having a relatively short latency. According to the method of the invention the first functional unit during execution of an instruction of the first type receives input data and provides output data, according to which method the output data is processed by the second functional unit during said execution and/or the input data is generated by the second functional unit during said execution.

The invention also provides for a method for compiling a program into a sequence of instructions for operating a processing device according to the invention. According to this method of compiling

a model is composed which is representative of the input/output operations involved in the execution of an instructions by a first functional unit,

on the basis of this model instructions for the one or more second functional units are scheduled for providing input data for the first functional unit when it is executing an instruction in which said input data is used and/or for retrieving output data from the first functional unit when it is executing an instruction in which said output data is computed.

These and other aspects of the invention are described in more detail with reference to the drawing. Therein

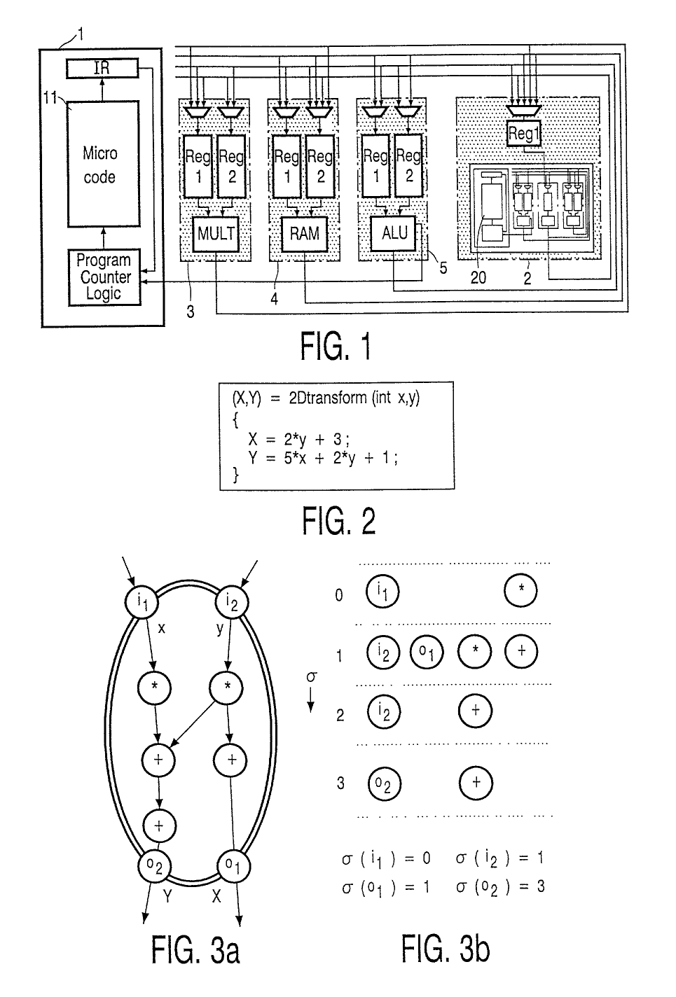

FIG. 1 shows a data processing device,

FIG. 2 shows an example of an operation which may be executed by the data processing device of FIG. 1,

FIG. 3A shows the signal flow graph (SFG) of the operation,

FIG. 3B shows the operation's schedule and its time shape function,

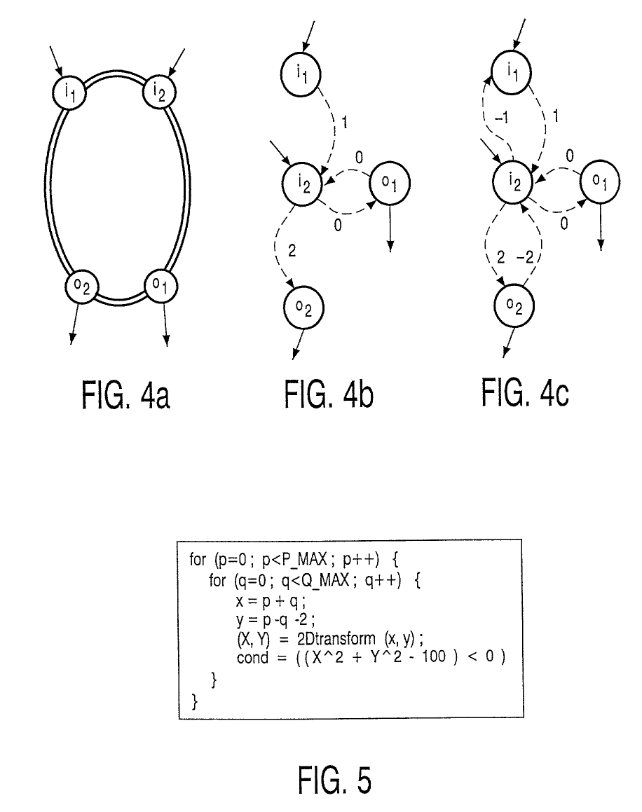

FIG. 4A schematically shows the operation of FIG. 2,

FIG. 4B shows a signal flow graph for schedulating execution of the operation of FIG. 4A at a holdable custom functional unit (FU),

FIG. 4C shows a signal flow graph for schedulating execution of the operation of FIG. 4A at a custom functional unit (FU) which is not holdable,

FIG. 5 shows a nested loop which includes the operation of FIG. 2,

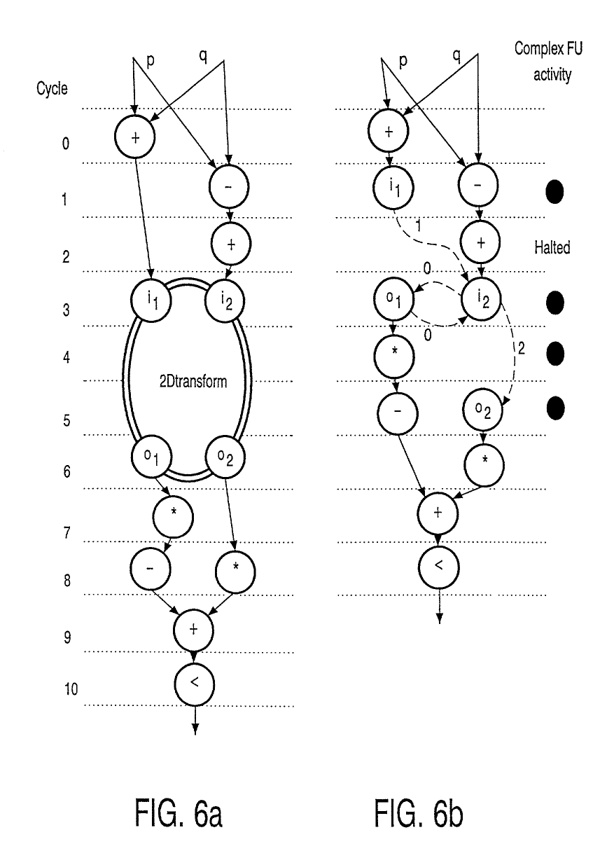

FIG. 6A shows the traditional schedule of the nested loop of FIG. 5 in a SFG,

FIG. 6B shows the schedule of said nested loop in a SFG according to the invention.

FIG. 1 schematically shows a data processing device according to the invention. The data processing device at least comprises a master controller 1, a first functional unit 2 which includes a slave controller 20, a second functional unit 3. The two functional units 2, 3 share a memory 11 comprising a micro code as common memory means. The device is programmed for executing an instruction by the first functional unit 2, wherein the execution of said instruction involves input/output operations by the first functional unit 2. The output data of the first functional unit 2 is processed by the second functional unit 3 during said execution and/or the input data is generated by the second functional unit 3 during said execution. In the embodiment shown the data processing device comprises further functional units 4, 5.

The embodiment of the data processing device shown in FIG. 1 is characterized in that the first functional unit 2 is arranged for processing instructions of a first type corresponding to operations having a relatively large latency and in that the second functional unit 3 is arranged for processing instructions of a second type corresponding to operations having a relatively small latency.

As an example, the possible variation of FFT algorithms may be considered which can be implemented using an “FFT radix-4” FU. Then this custom FU can be re-used while the algorithm is modified from a decimation-in-time to a decimation-in-frequency FFT. The VLIW processor may perform other fine-grain operations while the embedded custom FU is busy with its coarse-grain operation. Therefore, the long latency coarse-grain operation can be seen as a microthread [6] implemented on hardware, performing a separate thread while the remaining datapath's resources are performing other computations, belonging to the main thread.

Before introducing the scheduling problem, the Signal Flow Graph (SFG) [7][8][9] is defined as a way to represent the given application code, An SFG describes the primitive operations performed in the code, and the dependencies between those operations.

Definition 1. Signal Flow Graph SFG.

A SFG is a 8-tuple (V, I, O, T, E_{d}, Eₛ, w, δ), where:

V is a set of vertices (operations),

I is the set of input,

O is the set of output,

T [symbol] V×I∪O is the set of I/O operations' terminals,

Ed [symbol] T×T is a set of data edges,

Es [symbol] T×T is a set of sequence edges, and

w: Es→Z is a function describing the timing delay (in clock cycles) associated with each sequence edge.

δ: V→Z is a function describing the execution delay (in clock cycles) associated with each SFG's operation.

In the definition of the SFG a distinction is made between directed data edges, and directed and weighted sequence edges. They impose different constraints in the scheduling problem where “scheduling” is the task of determining for each operation v∈V, a start time s(v), subject to the precedence constraints specified by the SFG. Formally:

Definition 2. Traditional Scheduling Problem.

Given a SFG(V, I, O, T, Ed, Es, w, δ), find an integer labeling of the operations s: V→Z⁺ where:

s(vⱼ)≧s(vᵢ)+δ(vᵢ) ∀i, j, h, k: ((Vᵢ, Oₕ), (Vⱼ, iₖ))∈Ed

s(vⱼ)≧s(vᵢ)+w((tᵢ, tⱼ)) ∀i, j: (tᵢ, tⱼ)∈Es

and the schedule's latency: max_{i=1. . n}{s(vᵢ)} is minimum.

In the scheduling problem, as defined above, a single decision is taken for each operation, namely its start time. Because the I/O timeshape is not included in the analysis, no output signal is considered valid before the operation is completed. Likewise, the operation itself is started only if all input signals are available. This is surely a safe assumption, but allows no synchronization between the operations' data consumption and production times and the start time of the other operations in the SFG.

Before formally stating the problem, an operation's timeshape is defined as follows:

Definition 3. Operation's timeshape

Given an SFG, for each operation v∈V, a timeshape is defined as the function σ: T_{V}→Z⁺,

where:

Tᵥ={t∈T|t=(v, p), with p∈I∪O}

is the set of I/O terminals for operation v∈V.

The number assigned to each I/O terminal models the delay of the I/O activity relatively to the start time of the operation. Hence, for an operation of execution delay δ, the timeshape function associates to each I/O terminal an integer value ranging from 0 to δ-1. An example of operation's timeshape is depicted in FIG. 3.

In the traditional scheduling problem, each operation is seen as atomic in the graph. In order to exploit the notion of the operation's I/O timeshape, the scheduling problem is revisited. Where a single decision was taken for each operation, now a number of decisions are taken. Each scheduling decision is aimed to determine the start time of each I/O terminal belonging to a given operation. Hence, the definition of the revisited scheduling problem taking into account operations' timeshapes is the following:

Definition 4. I/O Timeshape Scheduling Problem:

Given a SFG and a timeshape functions for each operation v∈V in the SFG, find an integer labeling of the terminals s:T→Z⁺, where:

s((vⱼ, iₖ))≧s((vᵢ, oₕ))∀i, j, h, k: (t(vᵢ, oₕ), (vᵢ, iₖ))∈E_{d}

s(tⱼ)≧s(tᵢ)+w((tᵢ, tⱼ))∀i, j: (tᵢ, tⱼ)∈Eₛ

and the schedule's latency:

maxiᵢ₌₁ . . n{s(vᵢ)} is minimum.

It is important to notice that, introducing the concept of timeshape, the operation's latency function δ is not needed anymore and a scheduling decision is taken for each operation's terminal. The schedule found must satisfy the constraints on data edges, sequence edges, and respect the timing relations on the I/O terminals, as defined in the timeshape functions. In order to exploit the I/O timeshape characteristic of operations, the timeshape function σ is translated in a number of sequence edges, added in the set Eₛ. These extra constraints impose that the start times of each I/O operation terminal, for any feasible schedule, are such that the timeshape of the original coarse-grain operations is respected.

The translation of the timeshape function into sequence edges is done in a different way depending on whether the FU implementing the coarse-grain operation, can or cannot be stopped during its computation. This will be discussed in more detail with reference to FIG. 4. If the operation can be halted, then the timeshape of the operation can be stretched, provided that the concurrence and the sequence of the I/O terminals are kept. If the unit cannot be halted then an extra constraint must be added in the graph, to make sure that not only the sequence but also the relative distance between I/O terminals is kept as imposed by timeshape function.

By way of example two I/O terminals are considered which belong to the same original coarse-grain operation, namely t₁, and t₂. Then three different cases can happen:

### 1) Concurrency

If two I/O terminals, t₁, and t₂, take place during the same cycle according to the timeshape of the coarse-grain operation, then two sequence edges are added. Those extra edges guarantee that the operations t₁, and t₂ in any feasible schedule, for the given SFG, will take place in the same cycle (e.g. in FIG. 4B, o₁ and i₂).

If σ(t₁)=σ(t₂) then (t₁, t₂), (t₂, t₁)∈Eₛ with w(t₁, t₂)=w(t₂, t₁)=0

According to the definition of the revisited scheduling problem, those two added edges impose that:

s(t₁)≧s(t₂) and s(t₂)≧s(t₁)

### 2) The Serialization (hold-able operation)

If two I/O terminals, t₁ and t₂, are not concurrent according to the coarse-grain operation's timeshape, then a sequence edge is added. This extra edge guarantees that the order of the two operations will be kept in any feasible schedule. Anyway, it allows that operation t₂ can be postponed relatively to operation t₁, (e.g. in FIG. 4B, i₁ and i₂).

If s(t₂)−s(t₁)=λ>0 then (t₁, t₂)∈Eₛ with w(t₁, t₂)=λ

According to the definition of the revisited scheduling problem, this added edge imposes that: s(i₂)≧s(i₁)+w(i₁, i₂)=s(i₁)+λ

hence: s(i₂)−s(i₁)≧λ

### 3) Serialization (not hold-able operation)

The distance between the start times of the two I/O terminals, t₁, and t₂, is imposed, for any feasible schedule, as defined by the coarse-grain timeshape (e.g. FIG. 4C, i₁ and i₂). This is done adding two sequence edges: If s(t₂)−s(t₁)=λ>0 then (t₁, t₂), (t₂, t₁)∈Eₛ with w(t₁, t₂)=λ and w(t₂, t₁)=−λ

According to the definition of the revisited scheduling problem, those two added edges impose that:

s(t₂)≧s(t₁)+w(t₁, t₂)=s(t₁)+λ

s(t₁)≧s(t₂)+w(t₂, t₁)=s(t₂)−λ

From the last two equations, it follows that the difference in the starting time between t₁, and t₂ is exactly equal to that imposed in the timeshape.

Hence:

s(t₂)−s(t₁)=λ

For each operation, the method adds a significant number of edges, in the order of |I∪O|². However, many of them can be pruned away, for instance introducing a partial order in the set of the operation's terminals. The pruning step is mostly trivial and therefore, herewith not described. Once the operations are described by their collection of I/O operations and the sequence edges are added, the SFG is scheduled using known and traditional techniques. Provided that the constraints due to the operations'timeshape are respected, the I/O terminals of each operation are now de-coupled from each other and can be scheduled independently.

By way of example it is assumed that the given application is performing intensively the “2Dtransform” function as shown in FIG. 2. To make the example more realistic, the function considered is performing a 2D graphic operation. It takes the vector (x,y) and returns the vector (X,Y), according to the code as depicted in FIG. 2. In order to improve the processor's performance the “2Dtransform” is implemented in hardware on a custom FU. Since the function is performed on hardware, it can be truly considered a single coarse-grain operation. The signal flow graph for this function is depicted in FIG. 3A. A feasible internal schedule for the (coarse-grain) operation is depicted in FIG. 3B, where one adder and one multiplier, both with a latency of one cycle, are available within the custom FU. The operation has four I/O terminals and it is performed by the custom FU in four clock cycles, σ=0, . . . , 3.

In this example, although the FU is active during all the four cycles (FIG. 3B), no I/O operation is performed in cycle 2. From the VLIW datapath, the internal operations performed by the custom FU are not visible and only the I/O timeshape is actually necessary to model the way the operation consumes and produces its data (FIG. 3B).

The original coarse-grain operation in FIG. 4A, whose content is now not depicted, is re-modeled as a graph of four single cycle operations, each of them modeling an I/O terminal. Sequence edges must be added to guarantee that the timeshape of the original coarse-grain unit is respected in any possible feasible schedule. In the Figures the sequence edges are indicated by dashed lines starting from a first operation and ending in an arrow at a second operation. In FIG. 4B, the derived SFG, modeling the behavior of a hold-able custom FU, is shown. In particular, I/O terminals that were performed in different cycles, according to the coarse-grain operation's timeshape, are serialized so that their order is preserved. In said Figure for example an edge w(i₁, i₂) having a value λ=1 is present between operations i₁ and i₂. Hence s(i₂)≧s(i₁)+w(i₁, i₂)=s(i₁)+λ. . Concurrence of two or more I/O terminals is kept as well. The time shape of FIG. 4B for example comprises a first edge w(i₂, o₁) and a second edge w(o₁, i₂) both having a value λ=0 so that concurrence of the operations i₂ and o₁ is garanteed. Hence, when a hold mechanism is available for the unit, the scheduler can lengthen the coarse-grain operation moving I/O terminals apart from each other, as far as the sequence edges are not violated. The effect on the hardware is that the FU might be stalled to better synchronize data communicated to and from other operations.

FIG. 4C shows the graph obtained by describing the coarse-grain operation in I/O terminals when no hold mechanism is available for the custom FU. In this case, the sequence edges added guarantee that the relative distance between any couple of I/O terminals, in any feasible schedule, cannot be different from that imposed by the coarse-grain operation's timeshape.

Now a code is considered where the function ‘2Dtransform’ mapped on a complex FU is used, as depicted in FIG. 5. In this example, the “2Dtransform” operation is part of a loop body, where other fine-grain operations, such as ALU operations and multiplication's, are performed as well. It is supposed that the code is executed on a VLIW processor containing in its datapath a multiplier, an adder and a “2Dtransform” FU.

The traditional schedule for the SFG of the above described loop body is depicted in FIG. 6A. The coarse-grain operation is regarded as “atomic” and no other operation is executed in parallel with it. In FIG. 6B the I/O schedule of the complex unit is expanded and embedded in the loop body's SFG. The complex operation is executed concurrently with other fine-grain operations. According to the schedule, data is provided for the complex FU to the rest of the datapath and vice versa when actually needed, thereby reducing the schedule's latency. When some data is not available to the complex FU and the computation cannot proceed further, the unit is halted (e.g. cycle 2 FIG. 6B). The stall cycles are implicitly determined during the scheduling of the algorithm. Using the proposed solution, the latency of the algorithm is reduced from 10 to 8 cycles. The number of registers needed has decreased as well. The value produced in cycle 0 in FIG. 6A has to be kept alive for two cycles, while the same signal in the schedule in FIG. 6B is immediately used. The proposed solution is efficient in terms of microcode area for the VLIW processor. The complex FU contains its own controller and the only task left to the VLIW controller is to synchronize the coarse-grain FU with the rest of the datapath resources. The only instructions that have to be sent to the unit are a start and a hold command. This can be encoded with few bits in the VLIW instruction word. The VLIW processor can perform other operations while the embedded complex FU is busy with its computation.

The long latency unit can be seen as a micro-thread implemented on hardware, performing a task while the rest of the datapath is executing other computations using the rest of the datapath's resources.

The validity of the method has been tested using an FFT-radix4 algorithm as a case study. The FFT has been implemented for a VLIW architecture with distributed register files, synthesized using the architectural level synthesis tool “A|RT designer” from Frontier Design, running on a HP-UX machine. The radix-4 function, which constitutes the core of the considered FFT algorithm, processes 4 complex data values and 3 complex coefficients, returning 4 complex output values. The custom unit “radix-4” contains internally an adder, a multiplier, and its own controller. The unit consumes 14 (real) input values and produces 8 (real) output values. Extra details of the “radix-4” FU are given in Table 1.

TABLE 1
The Radix4 Functional Unit.

| | latency | internal registers | internal resources |
|---|---|---|---|
| Radix4 FU | 26 cycles | 16 (218 bits) | 1 ALU, 1 MULT |

Three different VLIW implementations are tested, as depicted in Table 2. The architectures “FFT_org” and “FFT_{—}2ALU's”) contain the same hardware resources but they differ in the coarseness of the operations that they can execute.

TABLE 2
The tested datapath architectures.

| | Datapath Resources |
|---|---|
| FFT_org | 1 ALU, 1 MULT, 1 ACU, 1 RAM, 1 ROM |
| FFT_2ALU's | 2 ALU, 1 MULT, 1 ACU, 1 RAM, 1 ROM |
| FFT_radix4 | 1 ALU, 1 ACU, 1 RADIX4, 1 RAM, 1 ROM |

For each architecture instance, table 3 lists the performance of the implemented FFT radix4 algorithm in clock cycles and the dimension of the VLIW microcode memory, where the application's code is stored. If the first implementation (“FFT_org”) is taken as a reference, it can be observed in Table 3 that “FFT_{—}2ALU's” presents the higher degree of parallelism and the best performance.

TABLE 3
Performance and microcode's dimension, experimental results.

| | Per- | Microcode | | Micro- |
|---|---|---|---|---|
| | formance | (width × | Microcode | code |
| | (cycles) | length) | width vs. original | n. bits |
| FFT_org | 59701 | 76 * 82 | 100.0% | 6232 |
| FFT_2ALU's | 40145 | 95 * 61 | 125.0% | 5795 |
| FFT_radix4 | 49461 | 67 * 74 | 88.2% | 4958 |

However, the extra ALU available in the datapath must be controlled directly by the VLIW controller, and a large increment in the microcode's instruction width is noticed. On the other side, “FFT_radix4” reaches performance which is in between the first two experiments, but a much narrower microcode memory is synthesized. Usually, the part of the code where the parallelism is necessary is a small fraction of the entire code. If the FFT is a core functionality in a much longer application code then the microcode width, hence the ILP needed in “FFT_{—}2ALU's”, will not be exploited adequately in other portions of the code, leading to a waste of microcode area. “FFT_{—}2ALU's” and “FFT_radix4” both offer 2 ALUs and a Multiplier in architecture for processing the critical FFT loop body, but fewer bits are needed in the latter microcode to steer the available parallelism.

Table 4 lists, for each instance, the number of registers needed in the architecture. In particular, in the last architecture the total number of register is the sum of those present in the VLIW processor and those implemented within the “Radix4” unit. The experiments done confirm that scheduling the FFT SFG, exploiting the I/O timeshape of the “Radix4” coarse-grain operation, reduces the number of needed registers.

TABLE 4
Register Pressure, experimental results.

| | N. of registers | Registers total amount of bits |
|---|---|---|
| FFT_org | 57 | 673 |
| FFT_2ALU's | 60 | 710 |
| FFT_radix4 | 58 (42 + 16) | 698 (481 + 218) |

The method according to the invention allows for a flexible HW/SW partitioning where complex functions may be implemented in hardware as FUs in a VLIW datapath. The proposed “I/O timeshape scheduling” method allows for scheduling separately the start time of each I/O operation's event and, ultimately, to stretch the operation's timeshape itself to better adapt the operation with its surroundings. By using coarse-grain operations in VLIW architectures, it is made possible to achieve high Instruction Level Parallelism without paying a heavy tribute in terms of microcode memory width. Keeping VLIW microcode width small is an essential requisite for embedded applications aiming at high performances and coping with long and complex program codes.

References

[1] Jean-Yves Brunel, Alberto Sangiovanni-Vincentinelli, Yosinori Watanabe, Luciano Lavagno, Wido Kruytzer and Frederic Petrot, “COSY: levels of interfaces for modules used to create a video system on chip”, EMMSEC'99 Stockholm 21-23 June 1999.

[2] Pieter van der Wolf, Paul Lieverse, Mudit Goel, David La Hei and Kees Vissers, “An MPEG-2 Decoder Case Study as a Driver for a System Level Design Methodology”, Proceedings 7th International Workshop on Hardware/Software Codesign (CODES'99), pp 33-37, May 3-5 1999.

[3] Rob Woudsma et al., “R. E. A. L. DSP: Reconfigurable Embedded DSP Architecture for Low-Power/Low-Cost Telecommunication and Consumer Applications”, Philips Semiconductor.

[4] Texas Instruments, “TMS32OC6000 CPU and Instruction Set Reference Guide”, Literature Number: SPRU189D March 1999.

[5] Philips Electronics, “Trimedia, TM1300 Preliminary Data Book”, October 1999 First Draft.

[6] R. Chappel, J. Stark, S. P. Kim, S. K. Reinhardt, Y. N. Patt, “Simultaneous subordinate microthreading (SSMT)”, ISCA Proc. of the International Symposium on Computer Architecture, pp.186-95 Atlanta, Ga., USA, 2-4 May 1999.

[7] Bart Mesman, Adwin H. Timmer, Jef L. van Meerbergen and Jochen Jess, “Constraints Analysis for DSP Code Generation”, IEEE Transactions on CAD, pp 44-57, Vol. 18, No. 1, January 1999.

[8] B. Mesman, Carlos A. Alba Pinto, and Koen A. J. van Eijk, “Efficient Scheduling of DSP Code on Processors with Distributed Register files” Proc. International Symposium on System Syntesis, San Jose, November 1999, pp. 100-106.

[9] W. Verhaegh, P. Lippens, J. Meerbergen, A. Van der Werf et al., “Multidimensional periodic scheduling model and complexity”, Proceedings of European Conference on Parallel Processing EURO-PAR '96, pp. 226-35, vol. 2, Lyon, France, 26-29 August 1996.

[10] W. Verhaegh, P. Lippens, J. Meerbergen, A. Van der Werf, “PHIDEO: high-level synthesis for high throughput applications”, Journal of VLSI Signal Processing (Netherlands), vol.9, no. 1-2, p.89-104, January 1995.

[11] Frontier Design Inc, “Mistral2 Datasheet”, Danville, California Calif. 94506 U.S.A

[12] P. E. R. Lippens, J. L. van Meerbergen, W. F. J. Verhaegh, and A. van der Werf, “Modular design and hierarchical abstraction in Phideo”, Proceedings of VLSI Signal Processing VI, 1993, pp. 197-205.

1. Data processing device, at least comprising a master controller (1), a first functional unit (2) which includes a slave controller (20), a second functional unit (3), which functional units (2,3) share common memory means (11), the device being programmed for executing an instruction by the first functional unit (2), the execution of said instruction involving input/output operations by the first functional unit (2), wherein output data of the first functional unit (2) is processed by the second functional unit (3) during said execution and/or the input data is generated by the second functional (3) unit during said execution.

2. Data processing device according to claim 1, characterized in that the first functional unit (2) is arranged for processing instructions of a first type corresponding to operations having a relatively large latency and in that the second functional unit (3) is arranged for processing instructions of a second type corresponding to operations having a relatively small latency.

3. Data processing according to claim 1, having halt means controllable by the master controller (1) for suspending operation of the first functional unit (2).

4. A method of operating a dataprocessor device, which device comprises at least
a master controller (1) for controlling operation of the device
a first functional unit (2), which includes a slave controller (20), the first functional unit (2) being arranged for executing instructions of a first type corresponding to operations having a relatively long latency,
a second functional unit (3) capable of executing instructions of a second type corresponding to operations having a relatively short latency, wherein the first functional unit (2) during execution of an instruction of the first type receives input data and provides output data, according to which method the output data is processed by the second functional unit (3) during said execution and/or the input data is generated by the second functional unit (3) during said execution.

5. Method according to claim 4, characterized in that, the master controller (1) temporarily suspends operation of the first functional unit (2) during execution of instructions of the first type.

6. A method for compiling a program into a sequence of instructions for operating a processing device according to claim 1, according to which method a model is composed which is representative of the input/output operations involved in the execution of an instructions by a first functional unit (2), on the basis of this model instructions for the one or more second functional units (3) are scheduled for providing input data for the first functional unit (2) when it is executing an instruction in which said input data is used and/or for retrieving output data from the first functional unit (2) when it is executing an instruction in which said output data is computed.

7. A method according to claim 6, characterised in that the model is a signal flow graph.
